(19) United States
(12) Patent Application Publication
(10) Pub. No.: US 2019/0170354 A1
(43) Pub. Date: Jun. 6, 2019

(54) FUEL SPRAY NOZZLE

(71) Applicant: ROLLS-ROYCE plc, London (GB)

(72) Inventor: Kyriakoulis L. RESVANIS, Derby (GB)

(73) Assignee: ROLLS-ROYCE plc, London (GB)

(21) Appl. No.: 16/185,102

(22) Filed: Nov. 9, 2018

(30) Foreign Application Priority Data
Dec. 1, 2017 (GR) 20170100550

(51) Int. Cl. F23R 3/14; F02C 7/22; F23R 3/30; F23R 3/34; F23D 11/10

(52) U.S. Cl. CPC F23R 3/14; F02C 7/222; F23D 11/107; F23R 3/343; F23R 3/30

(57) ABSTRACT

A fuel spray nozzle is provided for atomising liquid in a gas, the nozzle comprising: a gas passage; a liquid passage; a prefilming surface positioned downstream of the liquid passage and the gas passage, and configured to receive liquid from the liquid passage and to receive gas from the gas passage; wherein the liquid passage terminates at an exit orifice upstream of the prefilming surface; and wherein the gas passage contains a flow perturbator upstream of the liquid passage exit orifice, to increase the turbulence of gas passing from the gas passage to the prefilming surface.

### CROSS-REFERENCE TO RELATED APPLICATIONS

This application is based upon and claims the benefit of priority from Greek Patent Application No. GR20170100550, filed on 1 Dec. 2017, the contents of which are herein incorporated by reference.

### BACKGROUND

### Technical Field

The present disclosure concerns a fuel spray nozzle, also known as a prefilming airblast spray nozzle.

### Description of the Related Art

In gas turbine combustion, prefilming airblast spray nozzles control the quantity and quality of mixing of air and fuel inside the combustor liner of gas turbine engines. To assist the mixing, a system of swirlers (axial or radial) and fuel circuits can be used. The swirlers spin air passing through them, and the fuel circuit can deliver fuel to the prefilming surfaces of the nozzle as a spinning film. When the fuel and air flows meet at the prefilming surface, the air flow shears the film towards the trailing edge of the prefilming surface causing the disintegration of the fuel film into fine droplets.

### SUMMARY

The characteristics of the air/fuel flow on the prefilming surfaces and the subsequent atomisation at the prefilmer trailing edge affect the combustion performance. An ideal fuel spray nozzle system would be the one which achieves a uniform atomisation of the film into fine droplets around the periphery of the nozzle. To date, atomization improvements of pre-filming fuel spray nozzles have focused on changing the relative velocity between air and fuel circuits, either through streamlining or through co-/counter swirling the flows.

The present invention aims to improve the atomisation from a prefilming surface in a spray nozzle.

According to one aspect of the invention there is provided a spray nozzle, for atomising liquid in a gas, comprising: a gas passage; a liquid passage; a prefilming surface positioned downstream of the liquid passage and the gas passage, and configured to receive liquid from the liquid passage and to receive gas from the gas passage; wherein the liquid passage terminates at an exit orifice upstream of the prefilming surface; and wherein the gas passage contains a flow perturbator upstream of the liquid passage exit orifice, to increase the turbulence of gas passing from the gas passage to the prefilming surface. The provision of the flow perturbator increases the turbulence in the gas approaching the prefilming surface and thus improves the atomisation.

The flow perturbator can be a protrusion within the gas passage. Optionally, the flow perturbator is a bluff body on both upstream and downstream sides. Alternatively the flow perturbator is a streamlined body on its upstream side and a buff body on its downstream side. In both scenarios, an increase in turbulence of the gas passing the flow perturbator is achieved.

Optionally the prefilming surface has a length over which gas received from the gas passage and liquid received from the liquid passage passes, and the flow perturbator is positioned upstream of the liquid passage exit orifice by at least one length of the prefilming surface. Optionally the flow perturbator is positioned upstream of the liquid passage exit orifice by no more than ten lengths of the prefilming surface. Such positioning gives the optimal improvements in the atomisation performance.

Optionally the flow perturbator extends around an entire circumference of the gas passage. Optionally a height of projection of the flow perturbator into the gas passage varies around a circumference of the gas passage. Alternatively, a height of projection of the flow perturbator into the gas passage is substantially uniform around a circumference of the gas passage.

Optionally a height of the projection of the flow perturbator into the gas passage is between 0.1 and 10 times a length of the prefilming surface, preferably from 0.2 to 5 times the length of the prefilming surface.

Optionally two or more of said flow perturbators can be provided. The flow perturbators can be positioned at different distances from the prefilming surface.

Optionally the spray nozzle can be a fuel spray nozzle for atomising a fuel for combustion in air. The improved atomisation performance leads to improved combustion characteristics in a fuel spray nozzle such as a fuel injector.

According to another aspect of the invention there is provided a gas turbine engine incorporating such a fuel spray nozzle.

A swirler may be provided in the gas passage up stream of the flow perturbator.

The gas and liquid passages may be concentric.

The liquid passage may be arranged concentrically around the gas passage.

A second gas passage may be arranged concentrically around the liquid passage.

The second gas passage may have a swirler.

The liquid passage may be a pilot fuel passage of a lean burn fuel spray nozzle.

The liquid passage may be a main fuel passage of a lean burn fuel spray nozzle.

The liquid passage may be a fuel passage of a rich burn fuel spray nozzle.

According to another aspect of the invention there is provided a method of atomising liquid in gas, comprising the steps of: supplying gas to prefilming surface via a gas passage; and supplying liquid to the prefilming surface via an exit orifice upstream of the prefilming surface; wherein the gas passage contains a flow perturbator upstream of the liquid passage exit orifice, to increase the turbulence of gas passing from the gas passage to the prefilming surface.

The skilled person will appreciate that except where mutually exclusive, a feature described in relation to any one of the above aspects may be applied mutatis mutandis to any other aspect. Furthermore except where mutually exclusive any feature described herein may be applied to any aspect and/or combined with any other feature described herein.

### DESCRIPTION OF THE DRAWINGS

Embodiments will now be described by way of example only, with reference to the Figures, in which:

FIG. 1 is a sectional side view of a gas turbine engine;

FIG. 2 is a section side view of a prior fuel injection arrangement suitable for a gas turbine engine;

FIG. 3 is a section side view of a fuel injection arrangement incorporating flow perturbators;

FIG. 4 is a section side view of different types of flow perturbators;

FIG. 5 depicts a flow perturbator;

FIG. 6 is a perspective view of the flow perturbator of FIG. 5 in a fuel injection arrangement;

FIG. 7 illustrates gas phase velocity fluctuations for a fuel injection arrangement with and without a flow perturbator; and

FIG. 8 illustrates sooting in a fuel injection arrangement with and without a flow perturbator.

### DETAILED DESCRIPTION

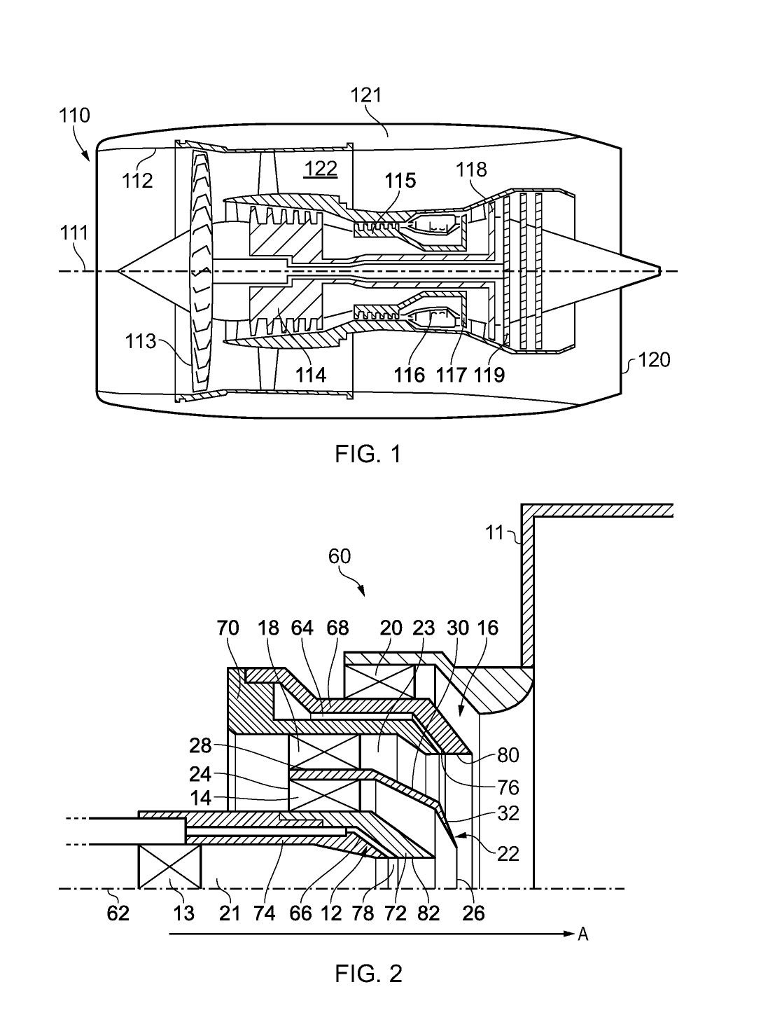

With reference to FIG. 1, a gas turbine engine is generally indicated at 110, having a principal and rotational axis 111. The engine 110 comprises, in axial flow series, an air intake 112, a propulsive fan 113, an intermediate pressure compressor 114, a high-pressure compressor 115, combustion equipment 116, a high-pressure turbine 117, an intermediate pressure turbine 118, a low-pressure turbine 119 and an exhaust nozzle 120. A nacelle 121 generally surrounds the engine 110 and defines both the intake 112 and the exhaust nozzle 120.

The gas turbine engine 110 works in the conventional manner so that air entering the intake 112 is accelerated by the fan 113 to produce two air flows: a first air flow into the intermediate pressure compressor 114 and a second air flow which passes through a bypass duct 122 to provide propulsive thrust. The intermediate pressure compressor 114 compresses the air flow directed into it before delivering that air to the high pressure compressor 115 where further compression takes place.

The compressed air exhausted from the high-pressure compressor 115 is directed into the combustion equipment 116 where it is mixed with fuel and the mixture combusted. The resultant hot combustion products then expand through, and thereby drive the high, intermediate and low-pressure turbines 117, 118, 119 before being exhausted through the nozzle 120 to provide additional propulsive thrust. The high 117, intermediate 118 and low 119 pressure turbines drive respectively the high pressure compressor 115, intermediate pressure compressor 114 and fan 113, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Referring now to FIG. 2, a fuel injection arrangement suitable for a gas turbine engine is generally indicated at 60. The fuel injection arrangement 60 is a form of prefilming airblast spray nozzle. The fuel injection arrangement 60 is attached to the upstream end of a gas turbine engine combustion chamber 11, part of which can be seen in FIG. 2. Throughout this specification, the terms “upstream” and “downstream” are used with respect to the general direction of a flow of liquid and gaseous materials through the fuel injection arrangement 60 and the combustion chamber 11 as shown by arrow A. Thus with regard to FIGS. 1 to 4, the upstream end is towards the left hand side of the drawing and the downstream end is towards the right hand side. The actual configuration of the combustion chamber 11 is conventional and will not, therefore, be described in detail. Suffice to say, however, that the combustion chamber 11 may be of the well known annular type or alternatively of the cannular type so that it is one of an annular array of similar individual combustion chambers or cans. In the case of a cannular combustion chamber, one fuel injection arrangement 60 would normally be provided for each combustion chamber 11. However, in the case of an annular combustion chamber 11, the single chamber would be provided with a plurality of fuel injection arrangement 60 arranged in an annular array at its upstream end. Moreover, more than one such annular array could be provided if so desired. For instance, there could be two coaxial arrays.

FIG. 2 shows a prior art piloted airblast lean direct fuel injector arrangement 60, which is similar to that described in detail in U.S. Pat. No. 6,272,840, the teachings of which are incorporated herein by reference. However, the main features are briefly described where particularly relevant to the present invention.

The injector arrangement 60 is generally annular and symmetrical about an injector axis 62 and is disposed at the upstream end of the combustion chamber 11.

The fuel injector arrangement 60 comprises a pilot or primary injector 12 and inner and outer pilot swirlers 13, 14 generally surrounding the pilot injector 12. A main airblast fuel or secondary injector 16 is concentrically positioned around the pilot injector 12 and inner and outer main swirlers 18, 20 are concentrically disposed radially inwardly and outwardly respectively of the main airblast fuel injector 16.

An annular air splitter 22 is located between the outer pilot swirler 14 and the inner main swirler 18. The air splitter 22 comprises an air inlet 24 and downstream, an air outlet 26. The air splitter 22, in the direction of air flow, further comprises a generally cylindrical portion 28, a radially inwardly tapered portion 30 and a downstream portion 32 that is tapered still further radially inwardly.

In use, fuel flows through galleries 64 and 66, which are liquid passages, and exits through orifices 76, 78, which are defined by annular and co-axial members 68, 70 and 72, 74, of the main and pilot fuel injectors 16 and 12 respectively. The annular members 68 and 72 are fuel prefilmers having prefilming surfaces 80, 82 that the fuel flows over prior to being shed from downstream edges into the swirling airflows. As such, the exit orifices 76, 78 are upstream of their respective prefilming surfaces 80, 82. At the same time as the fuel being supplied via the exit orifices 76, 78, air is supplied to the prefilming surfaces 80, 82 from the inner pilot swirler 13 and inner main swirler 18 respectively. The air from the inner pilot swirler 13 passes along gas passage 21, past the exit orifice 78, to the prefilming surface 82. Similarly, air from the inner main swirler 18 passes along gas passage 23, past the exit orifice 76, to the prefilming surface 80. As such, the air passing over the prefilming surfaces assists with the atomisation of the liquid fuel from the prefilming surfaces 80, 82.

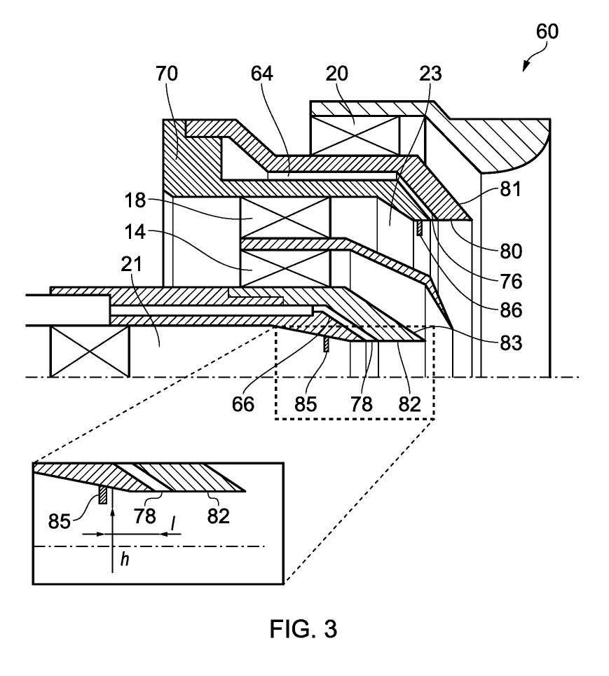

FIG. 3 shows a fuel injector spray nozzle 60 similar to that of FIG. 2 but provided with a flow perturbator 85 upstream of prefilming surface 82, and a similar flow perturbator 86 provided upstream of prefilming surface 80. Each flow perturbator 85, 86 is also provided upstream of the respective liquid passage exit orifice 78, 76, corresponding to each prefilming surface 82, 80.

The presence of the flow perturbators 85, 86 causes the gas supplied through the gas passages 21, 23 to increase in turbulence as it approaches the exit orifices 78, 76 and prefilming surfaces 80, 82. The increase in turbulence assists with the atomization of the liquid fuel from the prefilming surfaces 80, 82 by decreasing the break-up length for atomizing the liquid from the prefilming surface.

The enlarged portion of FIG. 3 illustrates a length/designating the distance of the flow protrusion from the start of the pre-filmer 82. In some embodiments, the distance/is at least one pre-filmer length. In other words, the flow perturbator 85, 86 is positioned upstream of the liquid passage exit orifice 78, 76 by at least one length of the prefilming surface 80, 82. In some embodiments, the distance/is no more than 10 pre-filmer lengths. In other words, the flow perturbators 85, 86 are positioned upstream of the respective liquid passage exit orifices 78, 76 by no more than 10 lengths of the respective prefilming surfaces 80, 82. By providing the perturbators within one to ten pre-filmer lengths of the pre-filming surface, the optimum increase in atomisation is achieved.

The enlarged portion of FIG. 3 also illustrates a height h. The height h of the flow perturbators 85, 86 in some embodiments is of the order of the respective pre-filmer length. In other words, the height of projection of the flow perturbators 85, 86 into their respective gas passages 21, 23 can be between 0.1 and 10 times the length of the respect prefilming surface 80, 82, and preferably from 0.2 to 5 times the length of the prefilming surface.

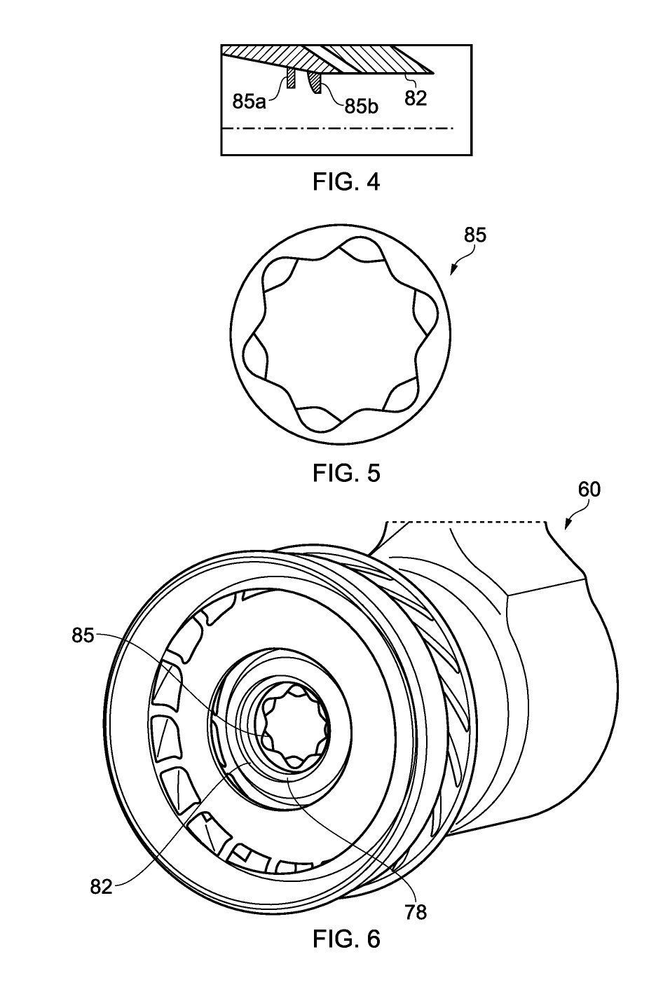

As illustrated in FIG. 3 the flow perturbators 85, 86 can be a protrusion into the respective gas passages 21, 23. The protrusion may present a bluff body to the flow of gas through the gas passage. In other words, the protrusion may represent a step in the inner surface of the gas passage, with a substantially rectangular cross-section. Alternatively, the protrusion may be streamlined to the side facing the oncoming flow, with a bluff/abrupt shape on the downstream facing side. This is illustrated in FIG. 4, in which flow perturbator 85A is of the bluff body type in both the upstream and downstream directions, whilst flow perturbator 85B has a streamlined upstream face, with a bluff downstream face. FIG. 4 also illustrates the possibility that more than one flow perturbator may be provided in each gas passage 21, 23. The flow perturbators may be provided at different distances from the prefilming surface.

The flow perturbator can extend around the entire circumference of the gas passage 21, 23. However, the height h of the flow perturbator may vary circumferentially. This is illustrated in FIG. 5 which shows an example flow perturbator 85 that has a scalloped inner surface. As such, the height of the flow perturbator (which would be measured radially from the outer edge, as shown in FIG. 5, to the inner edge) varies radially around the flow perturbator 85. In other alternatives, the height of the projection of the flow perturbator into the gas passage can be substantially uniform around the circumference of the gas passage. FIG. 6 illustrates the positioning of the flow perturbator of FIG. 5 in a fuel injector arrangement 60.

Use of the flow perturbator 85, 86 as described above helps deliver a fuel-air mixture-fraction field of improved uniformity through improved liquid-sheet atomization from the prefilming surfaces 82, 80. This also delivers an improvement in smoke/soot emissions. This is all achieved without requiring a drastic modification to the fuel spray nozzle or the technology required to manufacture one.

The improvements arise because, as the gas flow travels past the flow perturbator 85, 86, the flow is ‘tripped’, generating increased turbulent regions in the gas near the surface of the gas passage. These locally increased turbulence levels in turn change the frequency/wavelength of the instability that arises at the interface of the liquid and gas sheet. A change in the interphase (liquid-gas) instability directly results in a change of the primary and secondary breakup lengths resulting in smaller droplets at the same measurement plane.

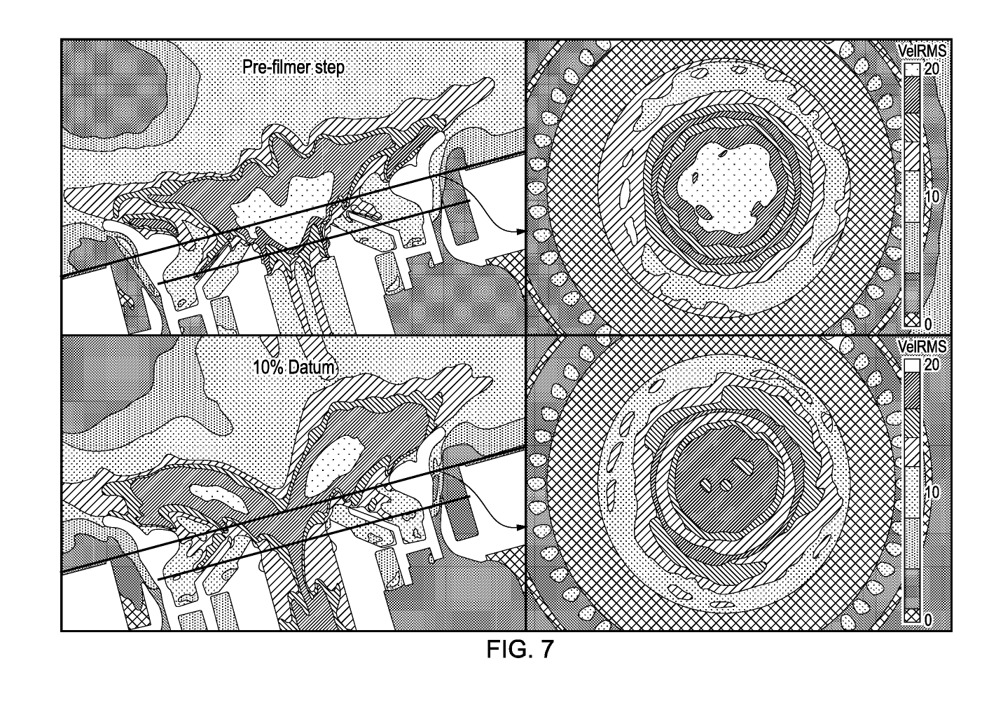

This is illustrated by FIG. 7, which depicts the increased gas phase velocity fluctuations (VelocityRMS, or VelRMS) for the fuel spray nozzle with the pre-filming steps.

FIG. 7 shows gas phase velocity fluctuations for a rich burn fuel nozzle. As such, it will be clear that the present invention is applicable to both rich burn fuel nozzles and lean burn fuel nozzles. The rich burn fuel nozzle shown in FIG. 7 comprises concentric inner, intermediate and outer gas passages, each of which has a swirler. The fuel passage is provided between the inner and intermediate gas passages and supplies fuel through an exit orifice upstream of a prefilming surface on the inner gas passage. Thus the flow perturbator is positioned in the inner gas passage upstream of the exit orifice.

It will thus also be appreciated that although the fuel injector 60 of FIG. 3 has a perturbator upstream of the prefilming surface of the pilot fuel injector 12 and a perturbator upstream of the prefilming surface of the main fuel injector 16 it is equally possible to only have a perturbator upstream of the prefilming surface of the pilot fuel injector 12 or to only have a perturbator upstream of the prefilming surface of the main fuel injector 16.

For completeness, it is noted that some rich burn fuel nozzles, compared to what is shown in FIG. 7, only have the inner two gas passages and respective swirlers, and the present invention is also applicable to those arrangements. Also, some lean burn fuel injectors, compared to what is shown in FIG. 3, have an additional gas passage and associated air swirler between the outer gas passage of the pilot fuel injector 12 and the inner gas passage 23 of the main fuel injector 16.

FIG. 7 shows VeIRMS for the gas phase in the streamwise (left-hand-side) and cross-stream (right-hand-side) directions, obtained from large eddy simulation (LES) calculations for a fuel spray nozzle both with the perturbator (top) and without (bottom). The increased velocity fluctuations are noticeable near the pre-filming surface in the stream-wise section on the left hand side of FIG. 7, within the dotted ellipse.

The presence of the flow perturbator slightly restricts the effective area (and thus discharge coefficient) of the whole fuel spray nozzle through subtle alteration of the shape of the precessing vortex core, and the introduction of a partial blockage in the gas passage (of the order ˜5-6%). However, this increased blockage may be offset by using a fuel spray nozzle with increased effective area thus maintaining the same overall air-to-fuel ratio.

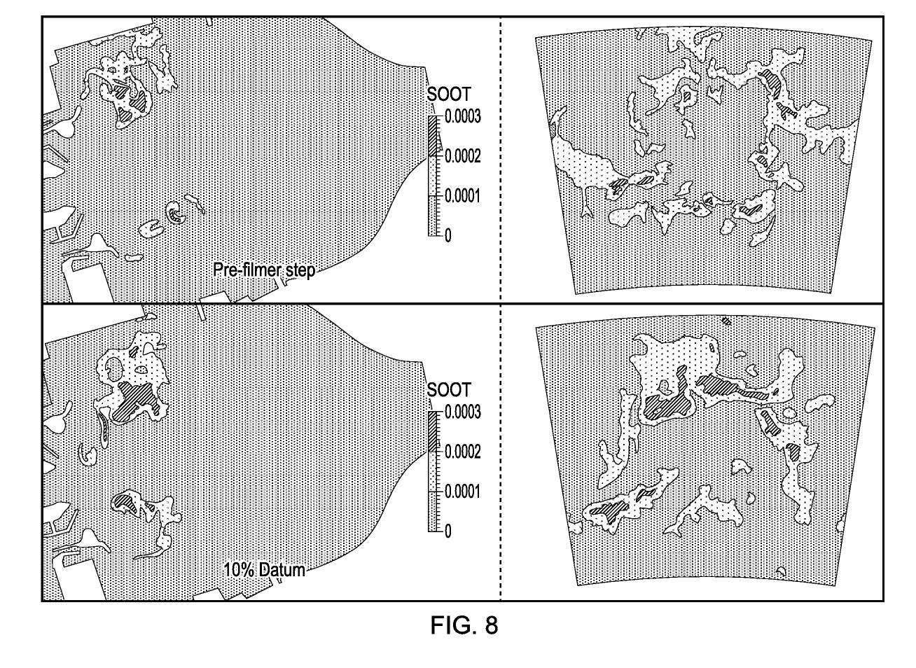

FIG. 8 depicts in a qualitative sense the reduction in sooting predicted by employing a perturbator design on two fuel-spray nozzles operating at identical air-to-fuel ratios. The figure presents instantaneous fuel-to-air fields and soot fields with and without the perturbator (top and bottom, respectively) for two types of fuel spray nozzle seals (left and right hand sides, respectively, shown in different section). Red colours indicate regions of high variable value while blues indicate regions of little to no variable value, respectively. It should be noted here that the improvement (i.e. reduction in variability) shown is a conservative one as the fuel droplet diameter distribution has not been decreased within the model for the flow perturbator scenario as would be expected in reality. The illustrated improvement is achieved solely through the introduction of increased gas phase turbulence intensity near the injection location, and so an even greater improvement would be expected if the injected droplet size was also decreased.

The above discussion has focussed on the particular scenario of a fuel spray nozzle, and the improved combustion performance imparted. However, it will be appreciated that the improved atomisation from the prefilmer will also bring advantages in other scenarios where consistency of droplet size is important, such as emissions control. Thus, although the embodiments discussed above all relate to the use of a spray nozzle in the context of a turbine engine, the invention is applicable in other fields too.

It will thus be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A fuel spray nozzle, for atomising liquid in a gas, comprising:
a gas passage;
a liquid passage;
a prefilming surface positioned downstream of the liquid passage and the gas passage, and configured to receive liquid from the liquid passage and to receive gas from the gas passage;
wherein the liquid passage terminates at an exit orifice upstream of the prefilming surface; and
wherein the gas passage contains a flow perturbator upstream of the liquid passage exit orifice, to increase the turbulence of gas passing from the gas passage to the prefilming surface.

2. A fuel spray nozzle according to claim 1, wherein the flow perturbator is a protrusion within the gas passage.

3. A fuel spray nozzle according to claim 1, wherein the flow perturbator is a bluff body on both upstream and downstream sides.

4. A fuel spray nozzle according to claim 1, wherein the flow perturbator is a streamlined body on its upstream side and a buff body on its downstream side.

5. A fuel spray nozzle according to claim 1, wherein the prefilming surface has a length over which gas received from the gas passage and liquid received from the liquid passage passes, and the flow perturbator is positioned upstream of the liquid passage exit orifice by at least one length of the prefilming surface.

6. A fuel spray nozzle according to claim 1, wherein the flow perturbator is positioned upstream of the liquid passage exit orifice by no more than ten lengths of the prefilming surface.

7. A fuel spray nozzle according to claim 1, wherein the flow perturbator extends around an entire circumference of the gas passage.

8. A fuel spray nozzle according to claim 1, wherein a height of projection of the flow perturbator into the gas passage varies around a circumference of the gas passage.

9. A fuel spray nozzle according to claim 1, wherein a height of projection of the flow perturbator into the gas passage is substantially uniform around a circumference of the gas passage.

10. A fuel spray nozzle according to claim 1, wherein a height of the projection of the flow perturbator into the gas passage is between 0.1 and 10 times a length of the prefilming surface.

11. A fuel spray nozzle according to claim 1, wherein a height of the projection of the flow perturbator into the gas passage is between 0.2 and 5 times a length of the prefilming surface.

12. A fuel spray nozzle according to claim 1, comprising two or more of said flow perturbators.

13. A fuel spray nozzle according to claim 12, wherein said flow perturbators are positioned at different distances from the prefilming surface.

14. A fuel spray nozzle according to claim 1, wherein the spray nozzle is a fuel spray nozzle for atomising a fuel for combustion in air.

15. A gas turbine engine incorporating a fuel spray nozzle according to claim 14.

16. A method of atomising liquid in gas, comprising the steps of:
supplying gas to prefilming surface via a gas passage; and
supplying liquid to the prefilming surface via an exit orifice upstream of the prefilming surface;
wherein the gas passage contains a flow perturbator upstream of the liquid passage exit orifice, to increase the turbulence of gas passing from the gas passage to the prefilming surface.

17. A fuel spray nozzle, for atomising liquid in a gas, comprising:
a gas passage;
a liquid passage arranged concentrically around the gas passage;
a second gas passage arranged concentrically around the liquid passage;
a prefilming surface positioned downstream of the liquid passage and the gas passage, and configured to receive liquid from the liquid passage and to receive gas from the gas passage;
wherein the liquid passage terminates at an exit orifice upstream of the prefilming surface; and
wherein the gas passage contains a flow perturbator upstream of the liquid passage exit orifice, to increase the turbulence of gas passing from the gas passage to the prefilming surface.

18. A fuel spray nozzle according to claim 17, wherein the liquid passage is a pilot fuel passage of a lean burn fuel spray nozzle.

19. A fuel spray nozzle according to claim 17, wherein the liquid passage is a main fuel passage of a lean burn fuel spray nozzle.

20. A fuel spray nozzle according to claim 17, wherein the fuel spray nozzle further comprising:
a third gas passage arranged concentrically around the second gas passage;
a second liquid passage arranged concentrically around the third gas passage;
a fourth gas passage arranged concentrically around the second liquid passage;
a second prefilming surface positioned downstream of the second liquid passage and the third gas passage, and configured to receive liquid from the second liquid passage and to receive gas from the third gas passage;
wherein the second liquid passage terminates at an exit orifice upstream of the second prefilming surface; and
wherein the third gas passage contains a second flow perturbator upstream of the second liquid passage exit orifice, to increase the turbulence of gas passing from the third gas passage to the second prefilming surface;
the liquid passage is a pilot fuel passage of a lean burn fuel spray nozzle and the second liquid passage is a main fuel passage of the lean burn fuel spray nozzle.
